(19) United States
(12) Patent Application Publication
(10) Pub. No.: US 2026/0251207 A1
(43) Pub. Date: Aug. 27, 2026

(54) Pneumatic Sport and Recreational Device

(71) Applicant: East Crane Industrial HK Limited, Hong Kong (CN)

(72) Inventor: Dahe ZHANG, Jiangmen City (CN)

(21) Appl. No.: 19/546,532

(22) Filed: Feb. 23, 2026

(30) Foreign Application Priority Data
Feb. 21, 2025 (CN) 202510193531.5
Feb. 21, 2025 (DE) 10 2025 000 783.3

(51) Int. Cl. F16H 25/22; F41B 11/71; F41B 11/723

(52) U.S. Cl. CPC F16H 25/2204; F41B 11/71; F41B 11/723

(57) ABSTRACT

Disclosed is a pneumatic sport and recreational device (2) for firing a projectile using compressed air in a firing direction (4), comprising: a compressed air chamber (22) in which a piston (24) is movably arranged to generate compressed air, an actuator (52), and a piston return element (34) for returning the piston (24) opposite to the movement direction of the actuator (52), characterized in that the actuator (52) is configured to move the compressed air chamber (22) opposite to the firing direction (4), wherein a compressed air chamber return element (32) is provided to return the compressed air chamber (22) opposite to the movement direction of the actuator (52), and a motion delay element (60) is present to delay the return of the piston (24) relative to the return of the compressed air chamber (22).

### TECHNICAL FIELD

The present invention relates to a pneumatic sport and recreational device according to the preamble of claim 1.

### BACKGROUND

A pneumatic sport and recreational device of this type is known from WO 2016/181506 A1, in which a recoil effect, referred to as blowback, is generated by a targeted redirection of compressed air. During a shot, part of the compressed air flows from a valve chamber into a piston chamber of a projectile carrier unit. This pressure buildup generates a recoil impulse that moves the projectile carrier unit backward. The movement occurs simultaneously with the projectile exiting the barrel, creating a noticeable recoil directly linked to the shot. A return spring stops the movement of the projectile carrier unit and returns it to its starting position. This mechanism mechanically combines the blowback with the actual firing process, providing the user with a certain recoil sensation.

### SUMMARY

The object of the present invention is to improve the known pneumatic sport and recreational device.

According to one aspect of the invention, a pneumatic sport and recreational device for firing a projectile by means of compressed air in a firing direction comprises a compressed air chamber in which a piston is movably arranged to build up compressed air, an actuator, and a piston return element for resetting the piston against the movement direction of the actuator. According to the invention, the actuator is configured to move the compressed air chamber counter to the firing direction, wherein a compressed air chamber return element is provided for resetting the compressed air chamber against the movement direction of the actuator, and a motion delay element is provided for delaying the reset of the piston relative to the reset of the compressed air chamber.

The concept underlying the specified pneumatic sport and recreational device is that conventional pneumatic sport and recreational devices, which fire a projectile using compressed air in a firing direction, do not generate explosive pressure waves and thus do not produce a recoil effect known as blowback. For the most realistic simulation of a firearm, such a replication of blowback is advantageous. While the initially described pneumatic sport and recreational device is capable of generating blowback to some extent, it lacks a repeating function. This means that while the device fires automatically, reloading and re-tensioning of the system do not occur independently but are instead linked to the movement of the projectile carrier unit. This results in a less flexible design with limited functionality. Additionally, the generated recoil is relatively weak because the moving mass is comparatively small. This leads to a less pronounced and less realistic recoil sensation than that of real firearms. Furthermore, the system is structurally complex, as it requires precise compressed air control to reliably trigger the blowback.

In contrast, the specified pneumatic sport and recreational device offers several advantages. The recoil is initiated just before the shot is fired, allowing for a more realistic replication of the recoil sensation of a real firearm. As a result, the shot feels softer and more stable since the impulse is not solely caused by projectile acceleration. Additionally, the device enables a very simple repeating function because the actuator can be chosen in such a way that it can be re-tensioned at any time without complex mechanics or complicated valve systems. This results in easier handling and potentially higher reliability in use. By utilizing the compressed air chamber as the moving mass instead of the entire projectile carrier unit, the recoil is more evenly distributed and more noticeably felt. The new system thus provides a significantly more realistic blowback simulation while reducing structural complexity.

In a further development of the specified pneumatic sport and recreational device, the actuator comprises a rack-and-pinion drive with a rack arranged on the compressed air chamber and a gearwheel that is provided with teeth over an angular range of less than 360°. This further development is based on the idea of providing the repeatability of the system mechanically through a reliable rack movement.

Rack movement is generally known from V2 and V3 gearbox technology, which has become the standard in electrically operated airsoft weapons. The V2 gearbox (Version 2) is a widely used design variant, particularly found in M4/M16-like airsoft replicas. It is characterized by a more elongated design and a centrally positioned spring guide. The V3 gearbox (Version 3) is a further development with a modified shape used in other weapon types such as AK models or the G36. It differs by having a more robust construction and a different arrangement of internal components, which is particularly advantageous for high loads and alternative drive mechanisms. Unlike conventional V2 and V3 gearbox technology, where the piston is driven by the rack-and-pinion system, the core idea of this further development is to drive the compressed air chamber with the rack-and-pinion system.

This results in higher energy efficiency compared to the initially described pneumatic sport and recreational device, as the mechanical coupling of the rack and gearwheel optimally converts pneumatic pressure into linear motion without significant losses due to air leaks or inefficient air redirection. This improves overall performance and reduces air consumption. At the same time, the use of V2 and V3 gearbox components ensures easy maintenance and interchangeability since many parts from the airsoft sector are already available in a modular fashion.

The construction also contributes to the durability of the mechanism, as the movement is controlled by the gearwheel, preventing abrupt, undamped stopping of components. This reduces wear and ensures a more stable, long-lasting construction. Additionally, the limited engagement angle of the gearwheel allows for a compact design that can be easily integrated into existing systems, particularly those based on the proven gearbox standard.

A further development of the specified pneumatic sport and recreational device comprises an actuator with a rack-and-pinion drive, where a rack is arranged on the compressed air chamber and a gearwheel is provided with teeth over an angular range of less than or equal to 180°. In this way, repeatability is achieved in a very simple manner, as the rack meshes directly with the gear mechanism in one direction, enabling a precise and reliable resetting movement. The rotation of the gearwheel ensures a controlled conversion of pneumatic energy into a mechanically regulated recoil movement. Since the gearwheel is only equipped with teeth over a limited angular range, force transmission occurs within a defined section, creating a clear separation between the backward and forward movement of the actuator. This results in a smooth and controlled resetting movement, similar to the functioning of a real firearm.

In another development of the specified pneumatic sport and recreational device, the motion delay element comprises a pivoting latch configured to releasably engage with a flange on the piston. This allows the movement delay between the piston and the compressed air chamber to be specifically controlled by having the pivoting latch hold the piston in a defined position for a predetermined period before permitting movement. This enables precise synchronization of the piston movement with other system processes, particularly with the air supply and the sequence of the blowback effect.

A key advantage of this construction is the flexible adjustment of the recoil characteristics. Since the pivoting latch locks the piston in a defined position, the timing of the recoil can be precisely controlled. This allows the recoil to be either synchronized more closely with the moment of the shot or intentionally delayed to simulate different realistic effects. As a result, the device can be adapted to various calibers or weapon models with differing recoil behaviors.

Another advantage lies in the mechanical decoupling of the piston movement from the compressed air chamber. While the previously described pneumatic sport and recreational device implements motion delay through direct airflow control, the mechanical engagement provides a more robust and wear-resistant solution. The piston remains securely in position until released by the pivoting latch, reducing uncontrolled air loss and inefficient movement sequences. This can also help optimize air consumption, as the air supply is used in a targeted and efficient manner.

An additional benefit is the improved control of the firing cadence. Since the piston is only released after a defined locking phase, the system’s timing can be fine-tuned. This is particularly useful in fully or semi-automatic systems to create a realistic and consistent firing pattern.

Furthermore, the use of a mechanical locking mechanism simplifies adjustment and maintenance. The pivoting latch can be designed so that its holding force can be adjusted through simple mechanical modifications, such as spring pressure or an adjustable locking position. This allows the user to easily modify the device’s behavior without relying on complex electronic or pneumatic control mechanisms.

In an additional development of the specified pneumatic sport and recreational device, the pivoting latch comprises a hook that can be pivoted into a locking position by the flange on the piston. This allows the piston to actuate the pivoting latch directly and without additional actuators, significantly simplifying the construction and reducing the number of moving parts. This leads to increased reliability and durability, as fewer components require maintenance or precise alignment.

Another advantage of this solution is the self-regulating mechanics. Since the pivoting latch is actuated by the piston, the system automatically adapts to different operating conditions. This means no additional sensors or control units are necessary to determine the correct locking time or optimal release moment. The mechanism operates purely mechanically and uses the piston’s movement itself to regulate the engagement, making the entire construction simpler, more robust, and less prone to malfunctions.

Additionally, this design improves the efficiency of the motion delay. By allowing the piston to directly engage the locking mechanism, the delay can be precisely coordinated with the system’s operation without requiring external control mechanisms. This enables a dynamic adjustment of the delay time based on factors such as air pressure, piston speed, or system load. Thus, the timing of the blowback mechanism can be finely tuned to optimally simulate different recoil profiles or firing modes.

Another practical advantage is wear reduction. Since the hook of the pivoting latch is actuated by the flange of the piston, unlocking occurs through a smooth, natural motion that does not cause additional mechanical shocks or excessive abrasion. This can significantly extend the system’s lifespan and reduce maintenance requirements.

Finally, this design allows for easy adaptation to different weapon models and configurations. The locking mechanism can be finely adjusted by modifying the geometry of the flange or hook to generate specific recoil and movement profiles. This makes the concept particularly well-suited for modular sport and recreational devices that aim to simulate various blowback effects or firing mechanisms.

In a further development of the pneumatic sport and recreational device, the pivoting latch comprises a locking shoulder opposite the hook relative to its pivot axis, under which a locking element can be slid in the locking direction. In this way, the locking element interacts mechanically with the pivoting latch, ensuring a robust, reproducible, and secure function. The mechanical interaction between the locking element and the pivoting latch enables precise and defined control of the motion delay without requiring additional electronic or pneumatic control mechanisms. This increases system reliability and reduces potential sources of error.

Another advantage lies in the durability of the locking unit, as loads are evenly distributed and localized wear is minimized. The direct mechanical interaction also makes the system less sensitive to temperature fluctuations or variations in pneumatic pressure. Additionally, this solution allows for precise control of the blowback timing, as the locking element is deliberately slid under the locking shoulder to release the piston at the desired moment. This not only enhances the device’s simulation properties but also enables targeted adjustments to the recoil behavior.

In a particular further development, the specified pneumatic sport and recreational device comprises the locking element with a locking stop shoulder, which is configured to receive a movement force from the compressed air chamber to move the locking element in the direction of the pivoting latch. As a result, the compressed air chamber moves both the pivoting latch and the locking element simultaneously, ensuring automatic synchronization. This direct coupling of movement prevents delays or inconsistencies that could arise from mechanical play or external control mechanisms.

Another advantage is that the system operates entirely without separate drives or additional control components, reducing complexity and susceptibility to failure. Since the movement force is derived directly from the compressed air chamber, the locking dynamics automatically adapt to the respective operating pressure. This ensures that unlocking always occurs with the same precise timing, regardless of minor fluctuations in pressure levels or wear on moving parts.

Additionally, this solution enables a compact design since no additional levers or actuating components are required. This contributes to increased reliability and reduced maintenance requirements. By directly linking the movement processes, it is also ensured that the locking element and the pivoting latch always operate in sync, ensuring a consistent and predictable repeating function. This not only enhances the functionality of the system but also improves the tactile recoil feel for the user, as the blowback mechanism operates without unintended delays or inconsistent unlocking moments.

In a preferred further development of the pneumatic sport and recreational device, the flange is conically shaped on a contact side with the locking stop shoulder. The conical flange ensures a surface contact of the pivoting latch instead of a point or line contact, thereby reducing localized stresses in the material. This prevents notch effects and uneven wear, which is particularly beneficial for the durability of the system under high load cycles.

Another advantage is that the conical shape optimally distributes the locking forces over a larger area, making the component more resistant to mechanical loads. Additionally, the conical shape can help guide the pivoting latch more smoothly during its unlocking movement, as it gradually disengages from the flange rather than abruptly snapping out of a defined 90° position. This minimizes abrupt movements, positively affecting the mechanical stress on the entire system while reducing unwanted vibrations or noise.

A further functional advantage of the conical design lies in the self-centering of the pivoting latch. Due to the slanted surface, the pivoting latch is automatically guided into the correct position when re-engaging, increasing the reliability of the locking mechanism and ensuring an accurate repeating motion. At the same time, the contact angle can be deliberately adjusted through a customized conicity to facilitate engagement or regulate the locking resistance, depending on the desired balance between holding force and ease of movement.

In a preferred further development of the pneumatic sport and recreational device, the locking element is arranged on a catch ramp running transverse to the movement direction of the locking element. In this way, effective tolerance compensation is achieved, as the sloped ramp gently guides the locking element into its final position and prevents it from jamming or being impaired by manufacturing tolerances. At the same time, the catch ramp reduces friction and mechanical resistance, allowing the locking element to move smoothly and enabling an uninterrupted and consistent movement sequence.

Another advantage is the self-centering effect of the locking element, as the catch ramp automatically compensates for minor deviations in component manufacturing, ensuring reliable locking. This also reduces mechanical stress on the components, as forces do not act abruptly on a single point but are evenly distributed. As a result, the risk of wear and material fatigue is reduced, increasing the system's overall lifespan.

Moreover, the catch ramp contributes to noise reduction by preventing the locking element from striking a rigid edge with a hard impact. Instead, it is guided into its position in a controlled and dampened manner, improving the acoustic perception of the device and enhancing user comfort. Additionally, the catch ramp optimizes force transmission by redirecting movement forces in such a way that the locking process requires less effort while still maintaining a high holding force in the locked state.

Finally, the catch ramp supports a defined and smooth unlocking motion by preventing the locking element from being released abruptly. Instead, it is controlled out of the locking position, which is particularly beneficial for high-frequency repeating actions. Overall, this further development results in a more robust, durable, and user-friendly mechanism that minimizes mechanical stress and wear while ensuring a precise and reliable locking function.

IIn a further refinement of the specified pneumatic sport and recreational device, the locking element comprises an unlocking stop shoulder, which is configured to receive a movement force from an unlocking actuator to release the pivoting latch. In this way, a separate unlocking mechanism can be used, operating independently of the locking process. This enables precise control over the unlocking timing, as it does not necessarily have to be directly linked to the locking sequence. Consequently, unlocking can be initiated at an optimal moment, which is particularly advantageous in variable operating modes or automated processes.

A key advantage of this arrangement is the flexibility in controlling the overall mechanics. While conventional systems often mechanically couple the unlocking and locking processes directly, this solution allows both operations to be managed independently. This makes it possible to adjust operating parameters such as delay times or process sequences without modifying the locking mechanism itself. This not only enhances the adaptability of the system but also optimizes movement sequences regarding efficiency and component stress.

Another advantage arises from the possibility of integrating different types of unlocking actuators. The unlocking process can be executed electrically, pneumatically, or mechanically via an additional control component. This allows the device to be easily adapted for various applications or control systems, such as semi-automatic or fully automatic operation modes. This increases versatility and facilitates integration into different user scenarios.

Additionally, this independence contributes to the durability of the mechanism, as the locking function is not affected by repeated force application during unlocking. This reduces wear and extends the lifespan of the components. Furthermore, the unlocking stop shoulder can be designed to require minimal force to release the pivoting latch, thereby reducing the required actuator force and lowering energy consumption.

Finally, this concept enables improved control over the system dynamics. The unlocking process can be delayed, accelerated, or restricted to a defined movement range without affecting the locking function. This allows for a finely tuned control of the device, enhancing both precision and operational safety.

In a particularly preferred refinement of the pneumatic sport and recreational device, the locking stop shoulder and the unlocking stop shoulder are arranged on opposite sides of the locking element in the movement direction of the locking element. This ensures a clear functional separation between the locking and unlocking mechanisms, allowing both processes to be optimized independently in terms of spatial arrangement. This increases the robustness of the system, as there is no mechanical interference between the two shoulders that could cause unintended blockages or malfunctions.

A key advantage of this configuration is the improved force distribution and the ability to apply different forces for locking and unlocking. Since the two stop shoulders are spatially separated, the locking element can be designed to maintain a particularly stable and load-bearing position in the locking direction while requiring lower forces for unlocking. This minimizes wear, particularly in scenarios where high holding forces are needed while keeping unlocking effort minimal.

Another advantage is the efficient integration of the locking element into a sequential or synchronized system. Since the unlocking shoulder is independent of the locking shoulder, both mechanisms can be actuated by different control logics or actuators without interfering with each other. This is especially beneficial in automated or variable operating modes where different movement sequences or delays are required.

Additionally, this arrangement enhances the maintenance-friendliness of the system. By distinctly separating the locking and unlocking mechanisms, individual components can be replaced or optimized without requiring modifications to the entire system. This increases modularity and simplifies future developments or adaptations to specific requirements.

Another significant advantage is the fault tolerance of the system. Since the unlocking mechanism operates independently of the locking process, a malfunction or unexpected blockage in the unlocking function cannot inadvertently release the locking mechanism. This increases operational safety and ensures that the locking function is only disengaged when explicitly intended. At the same time, the system can be designed so that unlocking requires a deliberate and controlled action, preventing accidental or uncontrolled unlocking.

This concept not only enhances mechanical stability but also improves functional safety and flexibility, making the device adaptable for a wide range of applications.

### BRIEF DESCRIPTION OF FIGURES

The properties, features, and advantages of this invention described above, as well as the manner in which they are achieved, become more apparent in connection with the following description of exemplary embodiments, which are explained in greater detail with reference to the drawings. The drawings show:

FIG. 1: A perspective view of a pneumatic sport and recreational device in the form of an air pressure pistol.

FIG. 2: A partially exploded view of the air pressure pistol from FIG. 1.

FIG. 3: A structural representation of an air pump mechanism of the air pressure pistol from FIG. 1.

FIG. 4: The air pump mechanism from FIG. 3 in a first operating state.

FIG. 5: The air pump mechanism from FIG. 3 in a second operating state.

FIG. 6: The air pump mechanism from FIG. 3 in a third operating state.

In the figures, identical technical elements are labeled with the same reference signs and are described only once. The figures are purely schematic and do not represent actual geometric proportions.

### DETAILED DESCRIPTION

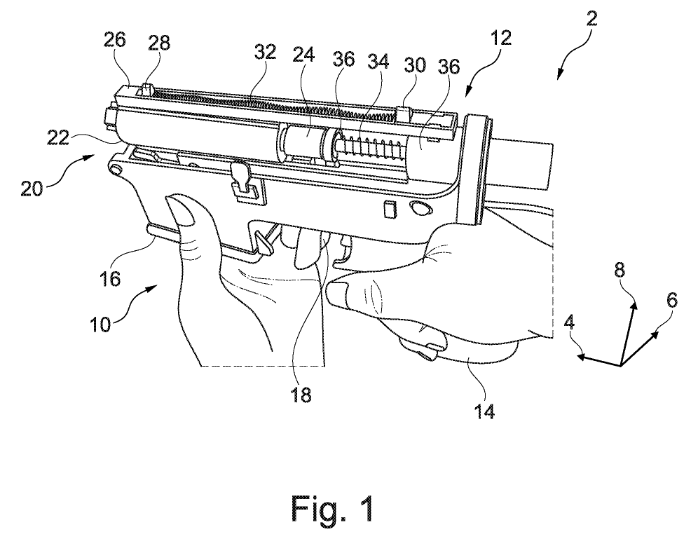

Reference is made to FIG. 1, which shows a perspective view of a pneumatic sport and recreational device in the form of an air pressure pistol 2. The air pressure pistol 2 is to be considered in a spatial framework defined by a firing direction 4, a transverse direction 6 perpendicular to the firing direction 4, and a height direction 8 perpendicular to both the firing direction 4 and the transverse direction 6.

The air pressure pistol 2 comprises, in a known manner, a lower housing 10 that contains all user-operable control elements and, in real firearms, often constitutes the legally relevant main component with a serial number. In the height direction 8, an upper housing 12 is mounted on the lower housing 10, enclosing the movable components necessary for firing a shot.

At the rear end of the lower housing 10 in the firing direction 4, a pistol grip 14 is attached, while at the front end, a magazine well 16 is provided for inserting a magazine containing projectiles to be fired. Between the pistol grip 14 and the magazine well 16, a trigger 18 is positioned to initiate a shot.

The upper housing 12 is partially cut away in the perspective of FIG. 1, exposing the internal components. It houses an air pump 20 with a cylindrical pressure chamber 22 extending in the firing direction 4 and a piston 24, which moves within the pressure chamber 22 in the firing direction 4, similar to known air pumps used, for example, for inflating vehicle tires. The distinctive feature of the air pressure pistol 2 is that, unlike conventional air pumps, the cylindrical pressure chamber 22 is arranged to be movable and is guided within an air chamber rail 26, which is positioned above it in the height direction 8.

For this purpose, the cylindrical pressure chamber 22 has an air chamber lug 28, which is inserted into a not-visible slot extending in the firing direction 4 within the air chamber rail 26, allowing the cylindrical pressure chamber 22 to move back and forth along the firing direction 4 while being guided by the air chamber rail 26. The air chamber rail 26 features a stationary rail lug 30 located behind the air chamber lug 28 in the firing direction 4, with a pressure chamber return element 32, here in the form of a coil spring, positioned between the air chamber lug 28 and the rail lug 30. This return element ensures that the cylindrical pressure chamber 22 is reset to its starting position in the firing direction 4.

Similarly, the piston 24 within the cylindrical pressure chamber 22 is also returnable in the firing direction 4 by means of a corresponding piston return element 34, which is also a coil spring. To achieve this, a rear spring seat 36 is positioned at the rear end of the upper housing 12 in the firing direction 4, and another spring seat 36 is provided at the rear end of the piston 24, with the piston return element 34 held between them to reset the piston to its starting position in the firing direction 4, similar to the cylindrical pressure chamber 22.

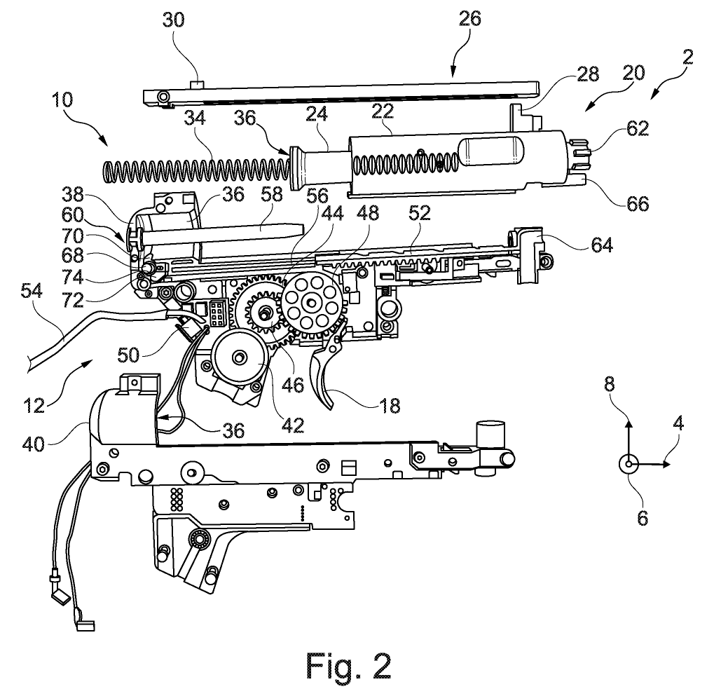

Reference is now made to FIG. 2, which presents a partially exploded view of the air pressure pistol 2 from FIG. 1. This depiction is used to explain the components housed within the lower housing 10 of the air pressure pistol 2, as far as necessary for understanding the design.

The lower housing 10 is composed of a rear left housing half 38, seen in the transverse direction 6, and a front right housing half 40. In the assembled state, the lower housing 10 accommodates, in addition to the trigger 18, a flywheel 42, a lower gear 44, a middle gear 46, an upper gear 48, and an electronic control unit 50.

The flywheel 42 is driven by an electric motor that is not visible in the drawing and is positioned beneath the lower gear 44 in the height direction 8. The lower gear 44, also referred to as a bevel gear, transmits the torque from the electric motor to the middle gear 46, which is located above it in the height direction 8 and is also known as a spur gear.

The middle gear 46 then transfers the rotational movement further upwards in the height direction 8 to the upper gear 48. The upper gear 48, also known as a sector gear, has teeth on only a portion of its circumference. This design enables a cyclical motion where the upper gear 48 engages with a rack 52 to control the movement of the pressure chamber 22 only during a specific phase of its rotation, which will be discussed in further detail later.

The control electronics 50 are connected to both the electric motor and the trigger 18. They regulate the power supply to the electric motor depending on the actuation of the trigger 18 and draw the required energy via a cable 54 from an electrical power source not further depicted. When the user pulls the trigger 18, an electronic signal is generated in the control electronics 50, which activates the power supply to the electric motor. The motor starts rotating and directly drives the flywheel 42, which serves as an energy buffer and ensures the smooth movement of the system. Since electric motors experience a torque surge upon sudden activation, the flywheel prevents abrupt movements and compensates for uneven loads within the gear mechanism. This results in a smoother and more material-friendly transmission of motion to the subsequent gears 44, 46, and 48.

Once the torque from the flywheel 42 is transmitted to the lower gear 44, it drives the middle gear 46 and further transfers the torque from the flywheel 42 to the upper gear 48. The middle gear 46 provides a gear reduction to ensure that the rotational speed is appropriately adjusted for operation. In this setup, torque is transmitted in multiple stages rather than acting directly from the motor on the upper gear 48. This has the advantage of enabling precise and controlled movement of the rack 52.

The upper gear 48 has a partial toothing along only part of its circumference, specifically over 180°. During its rotation, these teeth engage with the rack 52 only intermittently. The rack 52 is connected to the pressure chamber 22 and guided within a rack guide 56 in and against the firing direction 4. As a result, the rack 52 is linearly driven during an initial time interval and subsequently left free to move during a second time interval.

The rack 52 is positively connected to the pressure chamber 22 in the firing direction 4 to transmit the rotational motion from the electric motor as linear movement to the pressure chamber 22 and the piston 24. The piston 24 is slidably mounted on a guide rod 58 oriented in the firing direction 4 to ensure linear motion.

Driven by the upper gear 48, the rack 52 pushes the pressure chamber 22 and, with it, the piston 24 against the restoring force of the pressure chamber return element 32 and the piston return element 34 in the opposite direction to the firing direction 4 until the end of the toothing on the upper gear 48 is reached. At this moment, the positive engagement between the upper gear 48 and the rack 52 is released, causing the pressure chamber 22 to be abruptly freed. Due to the previously stored energy in the pressure chamber return element 32, the pressure chamber 22 accelerates forward in the firing direction 4, while the piston 24 is initially held in place in a manner yet to be described.

The sudden forward motion of the pressure chamber 22 generates an impulsive force transfer to the housing 10, 12, giving the user a tangible blowback sensation. This recoil effect arises because the pressure chamber 22 has a significant mass that abruptly moves in the firing direction 4, thereby transmitting an equal and opposite reaction force onto the lower housing 10, 12. The dynamics of this recoil impulse primarily depend on the kinetic energy of the pressure chamber 22, which in turn is derived from the stored force within the pressure chamber return element 32.

While the pressure chamber 22 is accelerated in the firing direction 4, the piston 24 of the air pump 20 must initially remain in its position; otherwise, no pressure can build up within the pressure chamber 22. To achieve this, the air pressure pistol 2 includes a motion delay element 60 that locks the piston 24 in place at first and only releases it later, ensuring the necessary pressure build-up within the pressure chamber 22.

The motion delay element 60 is designed to at least delay or actively control the movement of the piston 24 relative to the pressure chamber 22. This can be achieved through any mechanical or pneumatic locking device that releases the piston 24 only after a predetermined condition has been met, such as the pressure chamber 22 reaching a specific position in the firing direction 4 or after a set time delay. The release should be precisely timed to ensure both the necessary pressure build-up within the pressure chamber 22 for projectile acceleration and an unaffected blowback effect.

Structurally, the motion delay element 60 can take various forms. It may, for example, be a mechanical latch that engages into a locking position to hold the piston 24 stationary while the piston return element 34 is tensioned. Alternatively, a pneumatic or spring-based system may be used, which releases the piston 24 only once a certain pressure differential between the piston chamber and the ambient pressure has been reached. In this case, the delay element ensures that the stored energy is precisely released at the right moment. Another possibility is an electrically controlled switch that triggers the release of the piston 24 in response to a predefined event.

The motion delay ensures that the piston 24 is only released after the pressure chamber 22 has already moved fully forward and, in doing so, has triggered the blowback effect due to its momentum. Only after this does the pressure build up within the pressure chamber 22 as the piston 24 is released and compresses the air contained within.

The pressure built up within the pressure chamber 22 is then released through an air outlet 62 into a firing chamber (not shown) that holds a projectile. The projectile enters the firing chamber in a known manner via a projectile channel 64 and a slide 66 mounted on the pressure chamber 22.

The described process explicitly follows the functioning of a real firearm: In a firearm, the propellant powder in the cartridge case ignites first, causing an explosive pressure buildup in the chamber. This pressure then accelerates the projectile through the barrel toward the target. Similarly, in the air pressure pistol 2 described here, the blowback is triggered by the impulsive forward movement of the pressure chamber 22. Only immediately afterward does the movement of the piston 24 compress the air within the pressure chamber 22, which is then released into the firing chamber, accelerating the projectile.

This sequence ensures that the blowback effect in the pneumatic weapon closely resembles the behavior of a real firearm. The perceptible recoil occurs before the actual shot—just as in a firearm, where the recoil is generated by the explosion of the propellant charge immediately upon firing the cartridge, while the projectile itself leaves the barrel a moment later. This realistic timing enhances handling and shooting experience, particularly for users seeking an authentic simulation of a real firearm.

The following describes an example of a motion delay element 60 in a non-limiting manner in the form of a pivot lever. For the sake of clarity, it is hereinafter referred to as pivot lever 60. The pivot lever 60 is pivotably mounted about a pivot axis 68 oriented in the transverse direction 6 and has, relative to the pivot axis 68, a radially protruding hook 70 and, opposite the hook 70 with respect to the pivot axis 68, a locking shoulder 72. A torsion spring 74 wound around the pivot axis 68 ensures that the pivot lever 60 always returns to a defined starting position.

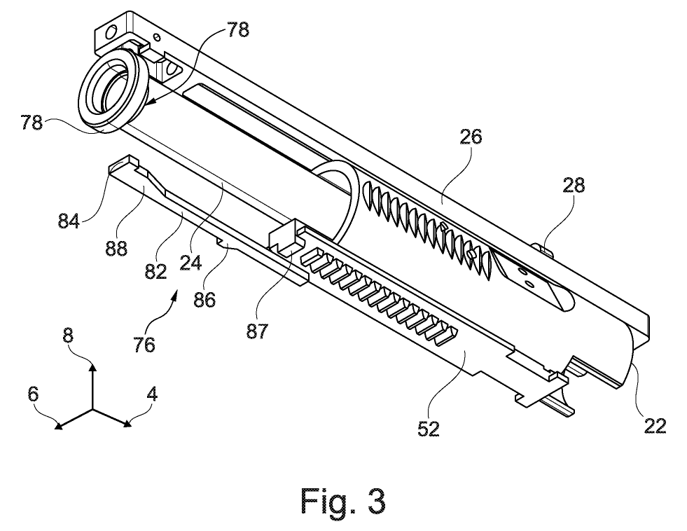

Reference is made to FIG. 3, which, as preparation for explaining the functionality of the pivot lever 60, describes a locking element 76 arranged on the air pump 20 to secure the pivot lever 60. The locking element 76 includes a control rod 82 extending in the firing direction 4 and has a locking stop shoulder 84 protruding opposite the transverse direction 6, as well as a release stop shoulder 86 protruding in the transverse direction 6. While the release stop shoulder 86 is directly mounted on the control rod 82, the locking stop shoulder 84 is seated on a ramp 88 that rises from the control rod 82 in the opposite direction to the firing direction 4.

Before discussing the locking element 76 in detail, the construction of the rear end of the piston 24, as seen in the firing direction 4, should first be examined. At the rear end of the piston 24, a flange 78 is formed with a conical front face 80 in the firing direction 4, which engages with the hook 70 of the pivot lever 60 when the pressure chamber 22 moves the piston 24 in the opposite direction to the firing direction 4. The flange 78 forms a contact surface for the hook 70, which, during the rearward movement of the piston 24, serves to pivot the pivot lever 60 about the pivot axis 68 and thereby establish a locking interaction with the locking element 76.

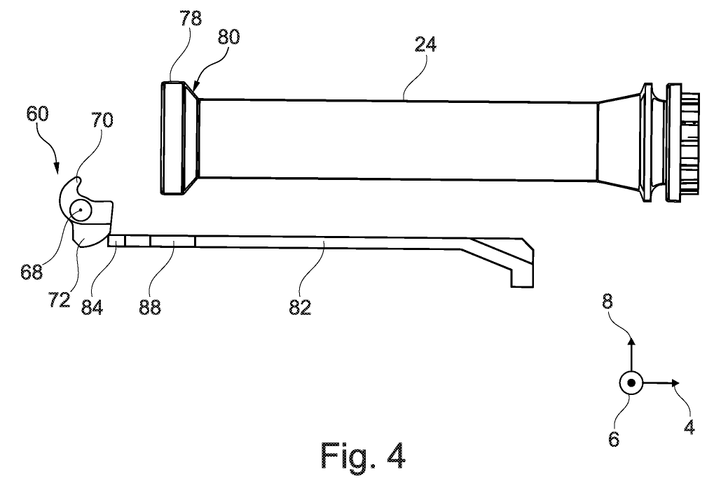

The function of the locking element 76 is explained below with reference to FIGS. 4 to 6, which show three different operating states of the pivot lever 60 and the locking element 76.

In the initial state, as shown in FIG. 4, the pivot lever 60 is reset to its starting position by the torsion spring 74. The hook 70 protrudes into the path of movement of the flange 78 on the piston 24. As the piston 24 moves opposite to the firing direction 4, the flange 78 contacts the hook 70, causing the pivot lever 60 to rotate. This results in the locking shoulder 72 being positioned above the locking stop shoulder 84 on the control rod 82 in the height direction 8.

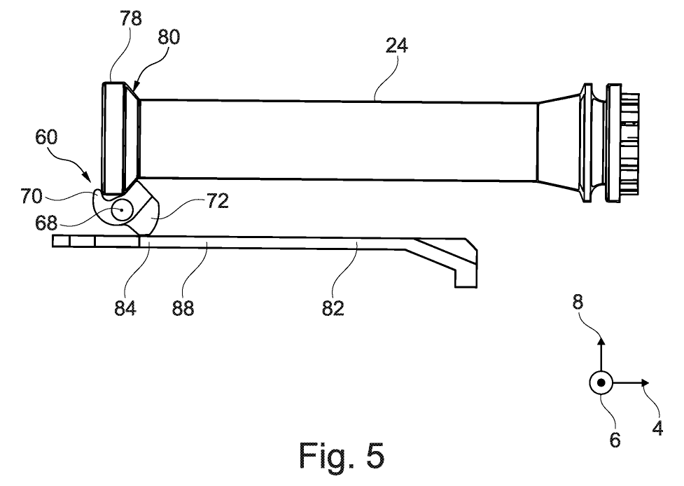

In this state, as shown in FIG. 5, the control rod 82 can be moved opposite to the firing direction 4 so that the locking stop shoulder 84 passes underneath the locking shoulder 72 in the height direction 8. This movement can be performed using an external force source. In the present configuration, the rack 52 has a thrust lug 87 on its rear side in the firing direction 4, which pushes the locking stop shoulder 84 opposite to the firing direction 4. The conical front face 80 of the flange 78 ensures a controlled lifting of the pivot lever 60, as it is precisely aligned parallel to the upper surface of the locking shoulder 72 at that moment. This geometric feature ensures that the locking shoulder 72 is smoothly guided over the locking stop shoulder 84 without unwanted tilting or additional frictional forces. This contributes to a smooth and predictable movement of the control rod 82, enabling a consistent and repeatable function of the motion delay element 60.

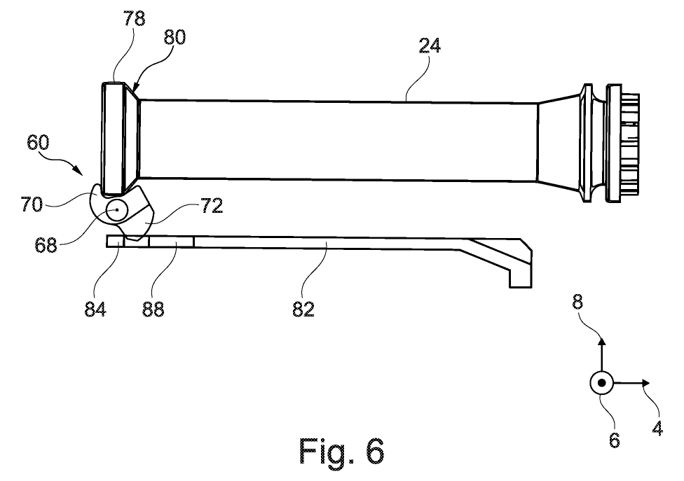

Once the locking stop shoulder 84 of the control rod 82 has fully passed underneath the locking shoulder 72 in the height direction 8, it is moved back in the firing direction 4. As soon as the locking stop shoulder 84 of the control rod 82 reaches the front side of the locking shoulder 72 in the firing direction 4, a positive locking engagement is established, as shown in FIG. 6. This configuration ensures that the pivot lever 60 is securely held in position until an intentional release occurs. The locking stop shoulder 84 additionally serves as a safety feature by preventing the pivot lever 60 from inadvertently rotating back unless the control rod 82 is actively moved further. This is particularly relevant in preventing unintentional piston 24 release due to vibrations or external influences.

The specific arrangement of the locking stop shoulder 84 in combination with the locking shoulder 72 creates a two-stage securing mechanism for the motion delay element 60. In the first stage, as shown in FIG. 5, the control rod 82 can move freely while the locking shoulder 72 is guided over the locking stop shoulder 84 by the conical front face 80. In the second stage, shown in FIG. 6, the movement of the control rod 82 in the firing direction 4 creates a mechanical blockade through the positive engagement between the locking stop shoulder 84 and the locking shoulder 72. This ensures that the piston 24 is reliably held in place until a targeted release occurs, allowing full pressure buildup in the pressure chamber 22 before the piston 24 is released to fire the shot.

The targeted release is then achieved by pulling the control rod 82 in the firing direction 4 at the release stop shoulder 86, causing the locking stop shoulder 84 to lift the locking shoulder 72 upward in the height direction 8. This action breaks the previously existing positive lock between the locking shoulder 72 and the locking stop shoulder 84. Once this form-fit engagement is lifted, the piston 24 can move freely in the firing direction 4 under the influence of the compressed air stored in the pressure chamber 22, as explained earlier.

After the release of the piston 24 and the corresponding pressure discharge, the restoring force of the torsion spring 74 ensures that the pivot lever 60 returns to its initial position. The control rod 82 can then be reset to its starting position by moving it opposite to the firing direction 4, automatically preparing the system for the next shot. This design ensures that the entire sequence of locking, delay, and release is precisely controlled and repeatable. Consequently, the blowback effect is generated in a highly realistic manner while incorporating a reliable repeating mechanism.

What is claimed is:

1. Pneumatic sport and recreational device (2) for firing a projectile using compressed air in a firing direction (4), comprising:
a compressed air chamber (22) in which a piston (24) is movably arranged to generate compressed air,
an actuator (52), and
a piston return element (34) for returning the piston (24) opposite to the movement direction of the actuator (52), characterized in that
the actuator (52) is configured to move the compressed air chamber (22) opposite to the firing direction (4),
wherein a compressed air chamber return element (32) is provided to return the compressed air chamber (22) opposite to the movement direction of the actuator (52), and a motion delay element (60) is present to delay the return of the piston (24) relative to the return of the compressed air chamber (22).

2. Pneumatic sport and recreational device (2) according to claim 1, wherein the actuator (52) comprises a rack-and-pinion drive with a rack (52) arranged on the compressed air chamber (22) and a gear (48), which has teeth over a circumferential angle of less than 360°, preferably less than or equal to 180°.

3. Pneumatic sport and recreational device (2) according to claim 1, wherein the motion delay element (60) comprises a pivot latch (60) configured to lock releasably with a flange (78) on the piston (24).

4. Pneumatic sport and recreational device (2) according to claim 3, wherein the pivot latch (60) comprises a hook (70) that can be pivoted into a locking direction by the flange (78) on the piston (24).

5. Pneumatic sport and recreational device (2) according to claim 4, wherein the pivot latch (60), relative to its pivot axis (68), has a locking shoulder (72) opposite the hook (70), under which a locking element (76) is slidable in the locking direction.

6. Pneumatic sport and recreational device (2) according to claim 5, comprising a locking element (76) with a locking stop shoulder (84), which is configured to move the locking element (76) toward the pivot latch (60) by receiving a movement force from the compressed air chamber (22).

7. Pneumatic sport and recreational device (2) according to claim 6, wherein the flange (78) has a conical design on a contact side with the locking stop shoulder (84).

8. Pneumatic sport and recreational device (2) according to claim 6, wherein the locking element (76) is arranged on a catch ramp (88) extending transversely to the movement direction of the locking element (76).

9. Pneumatic sport and recreational device (2) according to claim 5, wherein the locking element (76) comprises a release stop shoulder (86) configured to receive a movement force from a release actuator to unlock the pivot latch (60).

10. Pneumatic sport and recreational device (2) according to claim 9, wherein the locking stop shoulder (84) and the release stop shoulder (86) are arranged on different sides of the locking element (76) in the movement direction of the locking element (76).
